(19) United States
(12) Patent Application Publication
(10) Pub. No.: US 2025/0224183 A1
(43) Pub. Date: Jul. 10, 2025

(54) CAPILLARY STRUCTURE FOR UNIFORM TEMPERATURE PLATE, METHOD FOR MANUFACTURING THE SAME, AND UNIFORM TEMPERATURE PLATE

(71) Applicant: Raytech Precision Technologies (Shuyang) Co., Ltd., Suqian City (CN)

(72) Inventors: Guochuang Huang, Suqian (CN); Hezhi Wang, Suqian (CN); Bo Zhang, Suqian (CN); Chao Wang, Suqian (CN)

(21) Appl. No.: 18/824,865

(22) Filed: Sep. 4, 2024

Related U.S. Application Data
(63) Continuation of application No. PCT/CN2024/071004, filed on Jan. 8, 2024.

(51) Int. Cl. F28D 15/04; B22F 7/00; B22F 7/08; B23P 15/26

(52) U.S. Cl. CPC F28D 15/046; B22F 7/008; B22F 7/08; B23P 15/26; B22F 2301/10

(57) ABSTRACT

The present disclosure provides a method for manufacturing a capillary structure of a uniform temperature plate, and the uniform temperature plate belongs to the technical field of uniform temperature plates. The method for manufacturing the capillary structure of the present disclosure includes: providing copper paste with preset porosity and a template material with a regular structure; coating the template material and the copper paste on the uniform temperature plate, drying and sintering; and removing the template material by dissolution or high temperature decomposition to obtain the capillary structure with regular channels. The manufacturing method of the present disclosure is simple, the obtained capillary structure has regular channels, the thickness and the structure size are controllable, and the capillary effect is excellent. In addition, the capillary structure may be applied to the uniform temperature plate to obtain the ultra-thin uniform temperature plate.

### TECHNICAL FIELD

The present disclosure belongs to the technical field of uniform temperature plates, and particularly relates to a capillary structure for a uniform temperature plate, a method for manufacturing the capillary structure, and a uniform temperature plate.

### BACKGROUND

With high frequency and high speed development of electronic components and integrated circuit technologies, electronic components generate a large amount of heat during operation, for example, CPU of a computer has a heat flux density ranging from 60 W/cm² to 100 W/cm² during operation, and a semiconductor laser has a heat flux density even up to 10³ W/cm². The operating reliability of the electronic device is extremely sensitive to temperature, and the reliability is reduced by 5% every time the temperature of the device is increased by 1° C. at the level of 70° C. to 80° C. High heat flux poses a great threat to the reliability of normal operation of components, so that heat dissipation becomes a key problem of miniaturization development of electronic products. In order to ensure normal operation of electronic components, a radiator is usually additionally arranged on the electronic component to dissipate heat of the electronic components. Meanwhile, a uniform temperature plate with good thermal conductivity is additionally arranged between the radiator and the electronic component, and the uniform temperature plate is configured to uniformly distribute heat of heated electronic components and then dissipate heat through the radiator.

The uniform temperature plate is a heat conduction assembly capable of realizing rapid heat transfer by virtue of phase change of an internal operating fluid. The uniform temperature plate mainly includes: upper and lower cover plates or a metal pipe, a sealing head, a wick and a heat transfer medium. The capillary structure of the wick directly affects the performance of the uniform temperature plate, and the capillary structure is required to have a strong capillary force and low water flow resistance.

Secondly, as electronic products continue to develop toward miniaturization, the size of other components is required to be smaller and thinner, which makes the uniform temperature plate have more demanding requirements on the thickness, the ultra-thin uniform temperature plate with a thickness of 280 μm or less (for example, 240 μm) is generated, and the ultra-thin vapor chamber requires a thinner wick while ensuring heat transfer performance, such as a wick with a thickness of 80 μm or even 50 μm.

At present, there are many types of wicks of the uniform temperature plate, such as copper foam, copper mesh, composite copper mesh, and etched capillary structure, but these wicks are high in manufacturing cost, complex in manufacturing process, and high in commercial price, such as copper foam or composite copper mesh, and since the wicks such as copper foam, copper mesh/composite copper mesh have a large thickness, it limits the development of the uniform temperature plate to be thinner. Secondly, a copper paste screen printing method is also adopted to form the capillary structure, but the mass transfer flow resistance of the formed capillary structure is high, and the heat transfer performance of the uniform temperature plate is poor.

### SUMMARY

The present disclosure aims to solve at least one of the technical problems in the related art and provides a capillary structure for a uniform temperature plate, a method for manufacturing the capillary structure, and a uniform temperature plate.

In order to achieve the above objective, a first aspect of the present disclosure provides a method for manufacturing a capillary structure for a uniform temperature plate. The method includes:
providing copper paste having a preset porosity and a template material having a regular structure;
coating the template material and the copper paste on a substrate for drying and sintering; and
removing the template material by dissolution or high temperature decomposition to obtain the capillary structure with regular channels.

As an improvement, coating the template material having the regular structure and the copper paste on the substrate includes:
laying the template material on the substrate to form a template layer;
coating the copper paste on the template layer by coating or printing.

As an improvement, coating the template material having the regular structure and the copper paste on the substrate includes:
mixing the template material with the copper paste to form a mixed slurry;
coating the mixed slurry on the substrate by coating or printing.

As an improvement, the template material is any one of high molecular fabric, whisker, porous foam; and/or, a diameter of the template material ranges from 1 μm to 1 mm.

As an improvement, the high molecular fabric is one or more of nylon, polyurethane, polyethylene terephthalate fiber, polyamide fiber, acrylic fiber, polypropylene fiber and the like; and/or,
the whisker is organic whisker or inorganic whisker; and/or,
the porous foam material is one or more of polyurethane foam, polypropylene foam, polyethylene foam, PVC foam, EVA foam and melamine foam.

As an improvement, the drying temperature ranges from 80° C. to 150° C., and the drying time ranges from 5 min to 180 min; and/or,
the sintering temperature ranges from 300° C. to 850° C., and the sintering time ranges from 10 min to 480 min.

As an improvement, the copper paste includes copper powder, a pore-forming agent, a binder and a solvent.

As an improvement, the copper powder has a mass fraction of 30% to 95% and a particle size of 50 nm to 200 μm; and/or,
the pore-forming agent has a mass fraction of 0% to 85% and a particle size of 500 nm to 100 μm; and/or,
a mass fraction of the binder is 1% to 20%.

In a second aspect, the present disclosure further provides a capillary structure for a uniform temperature plate, which is manufactured by the manufacturing method described above.

In a third aspect, the present disclosure further provides a uniform temperature plate, the uniform temperature plate includes an upper cover plate, a lower cover plate and a capillary structure,
the capillary structure is located between the upper cover plate and the lower cover plate, and the capillary structure adopts the capillary structure described above.

The present disclosure provides a capillary structure for a uniform temperature plate, a method for manufacturing the same, and the uniform temperature plate, compared with the related art, it has the following beneficial effects:
1. compared with other types of wick, such as copper wire, copper mesh, composite copper mesh, copper foam, etc., the manufacturing method of the present disclosure is simple, and the capillary structure obtained by the method of the present disclosure has regular channels, the thickness and the structure size are controllable, and the capillary effect is excellent. In addition, the capillary structure may be applied to the uniform temperature plate to obtain the ultra-thin uniform temperature plate; and
2. compared with the copper paste screen printing method, the method of the present disclosure forms a capillary structure with regular channels, which has lower mass transfer flow resistance, improving the heat transfer performance of the uniform temperature plate to a greater extent.

### BRIEF DESCRIPTION OF DRAWINGS

FIG. 1 is a flowchart of a method for manufacturing a capillary structure according to an embodiment of the present disclosure.

### DESCRIPTION OF EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the drawing and the embodiments. It should be understood the embodiments described hereby is only to explain the present disclosure, not intended to limit the present disclosure. To enable those skilled in the art to better understand the technical solution of the present disclosure, the present disclosure is further described in detail below with reference to the accompanying drawings and embodiments. The described embodiments are only some of the embodiments of the present disclosure, rather than all embodiments. All other embodiments obtained based on the embodiments according to the present disclosure by those skilled in the art fall within the scope of protection of the present disclosure.

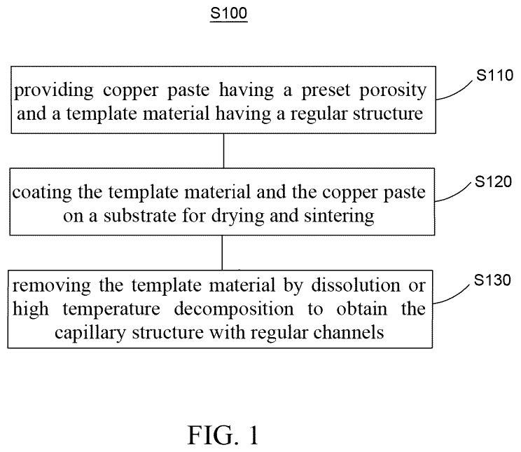

As shown in FIG. 1, in one aspect of the present disclosure, a method S100 for manufacturing a capillary structure for a uniform temperature plate is provided. The method S100 including following steps S110 to S130.
S110: a copper paste having a preset porosity and a template material having a regular structure are provided.

In some embodiments of the present disclosure, the copper paste is prepared with the certain preset porosity (for example, a porosity of 30% to 90%), and the copper paste should have the following features: copper powder with a certain particle size range and a certain fixed morphology, a pore-forming agent with a certain particle size range, etc., to meet the porosity requirements of capillary structure.

In some embodiments of the present disclosure, the copper paste includes copper powder, the pore-forming agent, a binder, and a solvent.

In some embodiments of the present disclosure, the mass fraction of the copper powder ranges from 30% to 95%, the copper powder is submicron in size, ranging from 50 nm to 200 μm, with a purity of ≥90%. In addition, the particle morphology of the copper powder may be spherical, dendritic or irregular small molten blocks, etc., which are not limited.

In some embodiments of the present disclosure, the mass fraction of the pore-forming agent ranges from 0% to 85%, the particle size of the pore-forming agent is 5 nm to 100 μm, and the pore-forming agent is mainly one or more of organic small molecule particles, polymer powder or inorganic salt, for example, one or more of ammonium chloride, urea, ammonium sulfate, citric acid and benzoic acid, and the particle shape may be spherical or irregular.

In some embodiments of the present disclosure, the pore-forming agent is volatilized or decomposed during sintering to form pores of the capillary structure, which may further improve the porosity of the capillary structure, increase the capillary suction force thereof, and improve the water absorption performance and heat transfer performance of the capillary structure to a greater extent.

In some embodiments of the present disclosure, the mass fraction of the binder ranges from 1% to 20%, and the binder is one or more of acrylic resin, epoxy resin, phenolic resin, etc.

In some embodiments of the present disclosure, the binder plays a role of bonding the copper powder, the pore-forming agent and the template material, and makes them attached to the uniform temperature plate strongly to avoid powder falling after drying.

In some embodiments of the present disclosure, the solvent is one or more of toluene, xylene, terpineol, acetone, and ethanol, etc.

In some embodiments of the present disclosure, the solvent plays a role of dissolving the binder, dispersing the copper powder and the pore-forming agent, and cooperates with the binder to uniformly and stably disperse and suspend the powder particles so as to form a slurry.

In some embodiments of the present disclosure, the template material is a material which may be decomposed into small molecules by high temperature decomposition, or is relatively soluble in acid, alkali or other solvents, so as to remove the small molecules. Moreover, the template material has the regular structure. The regular structure of the template material forms regular channels of the capillary structure by decomposing or dissolving the template material.

It should be understood that since the regular structure of the template material forms regular channels of the capillary structure, in some embodiments of the present disclosure, the template material is preferably a material having the regular structure, for example, high molecular fabric, whisker or porous foam. It can be appreciated that other template materials having the regular structure may also be selected, which is not limited, and the diameter of the template material is 1 μm to 1 mm. When whisker is used as the template material, the aspect ratio of the whisker is ≥10, so that the formed capillary structure has a good capillary effect.

In some embodiments of the present disclosure, the high molecular fabric may be one or more of nylon, polyurethane, polyethylene terephthalate fiber, polyamide fiber, acrylic fiber, polypropylene fiber, etc., and may be formed by warp and weft with different thicknesses and different numbers, and the woven warp and the weft gives a unique regular structure.

In some embodiments of the present disclosure, the template material of whisker includes organic whisker and inorganic whisker, the organic whisker may be one or more of cellulose whisker, poly (butyl acrylate-styrene) whisker, poly (4-hydroxybenzyl ester) whisker (PHB whisker), etc. The inorganic whisker may be one or more of calcium carbonate whisker, calcium sulfate whisker, aluminum oxide whisker, zinc oxide whisker, or potassium titanate whisker, etc., which have a certain aspect ratio structure, a specific cross section, and a stable size to form regular channels of the capillary structure.

In some embodiments of the present disclosure, the porous foam material may be one or more of polyurethane foam, polypropylene foam, polyethylene foam, PVC foam, EVA foam, melamine foam, etc., formed by a plurality of irregularly arranged and interconnected pores to form regular channels of the capillary structure.
S120: the template material and the copper paste are coated on a substrate for drying and sintering.

In some embodiments of the present disclosure, the template material and the copper paste are coated on the uniform temperature plate, and the uniform temperature plate coated with the template material and the copper paste is placed into an oven with the temperature of 80° C. to 150° C. and dried for 5 min to 180 min, so that the solvent is completely volatilized, and the formed dry material is strongly attached to the uniform temperature plate.

In some embodiments of the present disclosure, the dried uniform temperature plate is placed in a sintering furnace with the sintering temperature is set to be 300° C. to 850° C. and the sintering time is set to be 10 min to 480 min, so as to fully discharge glue and sinter, so that the capillary structure is well attached to the uniform temperature plate, the atmosphere used for sintering may be air, N₂, H₂, and mixed gas thereof, etc., which is not limited.

It should be noted that the uniform temperature plate includes an upper cover plate and a lower cover plate, generally, the capillary structure is located on the upper cover plate. Therefore, in the manufacturing method of the present embodiments, the template material having the regular structure and the copper paste may be coated on the upper cover plate of the uniform temperature plate.

It should be further noted that, in some embodiments of the present disclosure, the form in which the template material and the copper paste are coated on the uniform temperature plate is not limited, and the template material may be coated on the uniform temperature plate first, and then the copper paste is coated on the uniform temperature plate; or the copper paste and the template material may be mixed and then coated on the uniform temperature plate together, that is, as long as the template material and the copper paste are coated on the uniform temperature plate together, the regular structure of the template material may forms regular channels after drying and sintering.

In some embodiments of the present disclosure, the template material is laid on the uniform temperature plate to form a template layer; then, the template layer is coated with copper paste by coating or printing (for example, screen printing), and the uniform temperature plate is placed in the oven for drying to volatilize the solvent, and then placed in a sintering furnace for sintering, so that the regular structure of the template material is used as regular channels.

In some embodiments of the present disclosure, the template material is mixed with the copper paste to form a mixed slurry. The mixed slurry is coated on the substrate by coating or printing, and the regular structure of the template material is used as regular channels after drying and sintering.
S130: the template material is removed by dissolution or high temperature decomposition to obtain the capillary structure with regular channels. The width of the regular channels in the capillary structure is the same as the diameter of the template material.

It should be noted that, when the template material is removed by high temperature decomposition, the high temperature decomposition process of the template material may be performed synchronously with the sintering in step S120, that is, when the uniform temperature plate is placed in the sintering furnace for sintering, the template material is completely decomposed by high temperature volatilization at the sintering temperature to remove the template material.

It should be further noted that, when the template material is removed by dissolution, the sequence of the dissolution and the sintering steps is not limited, the sintering process may be carried out first and then the template material may be removed by dissolution, or the template material may be removed by dissolution first and then the sintering process may be carried out, that is, the dissolution process of the template material may occur before or after the sintering process.

In some embodiments of the present disclosure, when the template material is organic whisker or inorganic whisker, the whisker template material may be dissolved by acid, alkali or other solvents before sintering after drying, and then the capillary structure having regular channels is manufactured by sintering; or the whisker is removed in high temperature sintering process; or the whisker is dissolved by acid, alkali or other solvents after high temperature sintering.

In some embodiments of the present disclosure, the acid for dissolving the template material may be hydrochloric acid, nitric acid, sulfuric acid, etc. It can be appreciated that other acid solutions may also be selected.

In some embodiments of the present disclosure, the alkali for dissolving the template material may be one or more of sodium hydroxide, potassium hydroxide, lithium hydroxide, etc. It can be appreciated that other alkali solutions may also be selected.

In some embodiments of the present disclosure, the other solvents for dissolving the template material may be one or more of water, ethanol, acetone, ethyl acetate, copper butyl, tetrahydrofuran, formic acid, methanol, dichloromethane or trichloromethane, which are not limited to the solvents described above.

In the manufacturing method according to the embodiments, regular channels are provided by the template material having the regular structure, the porosity of the capillary structure is increased by the pore-forming agent in the copper paste, the copper slurry forms a main body framework of the capillary structure, the thickness and the structure size are controllable, the capillary effect is excellent. The structure not only may greatly improve the capillary suction force of the capillary structure, but also greatly reduces the flow resistance of the medium in the capillary structure, and the water absorption performance and the heat transfer performance of the capillary structure may be greatly improved.

In another aspect of the present disclosure, it provides a capillary structure for a uniform temperature plate, the capillary structure is manufactured by the method described above, and the method may be referred to the above description, which will not be elaborated here.

In some embodiments of the present disclosure, the capillary structure has regular channels, the width of the regular channels ranges from 1 μm to 1 mm, the porosity of the capillary structure ranges from 30% to 90%, and the capillary structure has the characteristics of a three-dimensional communication hole structure, which may greatly reduce the flow resistance of the medium transmitted in the capillary structure, improve the heat transfer performance of the uniform temperature plate, and be able to be applied to the ultra-thin uniform temperature plate.

In yet another aspect of the present disclosure, it provides a uniform temperature plate, the uniform temperature plate includes an upper cover plate, a lower cover plate, and the capillary structure described above, the capillary structure has regular channels, and the capillary structure is located between the upper cover plate and the lower cover plate.

The manufacturing method of the capillary structure for the uniform temperature plate will be further described below with reference to several specific examples.

### Example 1

The method for manufacturing the capillary structure in the Example includes the following steps.
S1, a polyethylene terephthalate fiber braided fabric with a line width of 30 μm was used as a template material. The template material was cut into the upper cover plate with the certain size and fixing it on the upper cover plate of a substrate. An ethanol solution of PMMA with a concentration of 30% was prepared, and was added with spherical copper powder in submicron size of 50% and urea powder of 20% to fully stir to manufacture a copper paste. The copper paste was coated on the upper cover plate of the uniform temperature plate by coating or screen printing. Then, the mixture was placed in an oven at 90° C. to 120° C. for 5 min to 120 min, and the solvent are dried away.
S2: the upper cover plate was placed into a solvent to fully dissolve the template material, for example, the solvent can be formic acid, methanol, dichloromethane or trichloromethane. Then, it was placed into a sintering furnace for sintering to obtain the upper cover plate having the capillary structure.
S3: the upper cover plate with the capillary structure was bonded with the lower cover plate by a solder paste to finally obtain a finished product of the uniform temperature plate. The temperature difference between a cold side and a hot side of the finished product was tested.

As shown in Table 1, the temperature difference between the cold side and the hot side of the uniform temperature plate manufactured in Example 1 is 1.5° C., which indicates that the uniform temperature plate of the Example has a good heat conduction effect.

### Example 2

The method for manufacturing the capillary structure in the Example includes the following steps.
S1, a polyethylene terephthalate fiber braided fabric with a line width of 100 μm was used as the template material. The template material was cut into the upper cover plate with the certain size and fixing it on the uniform temperature plate. An ethanol solution of PMMA with a concentration of 30% was prepared, and was added with spherical copper powder in submicron size of 50% and NH₄Cl powder of 20% to fully stirring to manufacture a copper paste. The copper paste was coated on the upper cover plate of the uniform temperature plate by coating or screen printing. Then the upper cover plate was placed in an oven at 90° C. to 120° C. for 5 min to 120 min, and the solvent are dried away.
S2: the upper cover plate was placed into a solvent to fully dissolve the template material, for example, formic acid, methanol, dichloromethane or trichloromethane. Then, the upper cover plate was placed into the sintering furnace for sintering to obtain the upper cover plate having the capillary structure.
S3: the upper cover plate with the capillary structure was bonded with the lower cover plate by a solder paste to finally obtain a finished product of the uniform temperature plate. The temperature difference between a cold side and a hot side of the finished product was tested.

As shown in Table 1, the temperature difference between the cold side and the hot side of the uniform temperature plate manufactured in Example 2 is 0.8° C., which indicates that the uniform temperature plate of the Example has a good heat conduction effect.

### Example 3

The method for manufacturing the capillary structure in the Example includes the following steps.
S1, a calcium carbonate whisker with an aspect ratio of 30 was used as the template material. An ethanol solution of PMMA with a concentration of 30% was prepared, and then was added with spherical copper powder in submicron size of 50% and NH₄Cl powder of 20% to fully stir to manufacture a copper paste. The calcium carbonate whisker was placed into the copper paste and then fully mixed. The copper paste was coated on the upper cover plate of the uniform temperature plate by coating. Then, the mixture was placed in an oven at 90° C. to 120° C. for 5 min to 120 min, and the solvent are dried away.
S2: the upper cover plate was placed into the sintering furnace for sintering. Finally, it was placed in an acid solution to fully dissolve the template material to obtain the upper cover plate having the capillary structure.
S3: the upper cover plate with the capillary structure was bonded with the lower cover plate by a solder paste to finally obtain a finished product of the uniform temperature plate. The temperature difference between a cold side and a hot side of the finished product was tested.

As shown in Table 1, the temperature difference between the cold side and the hot side of the uniform temperature plate manufactured in Example 3 is 1.1° C., which indicates that the uniform temperature plate of the Example has a good heat conduction effect.

TABLE 1
Temperature difference test results of Examples 1 to 3

| Testing | Example 1 | Example 2 | Example 3 |
|---|---|---|---|
| Average temperature | 1.5° C. | 0.8° C. | 1.1° C. |
| difference | | | |

To sum up, the temperature differences of the uniform temperature plates in the above Examples are within 2° C., which has a good heat conduction effect and a fast starting speed.

It can be understood that the above implementations are merely exemplary implementations used for illustrating the principles of the Examples of the present disclosure, but the present disclosure are not limited thereto. For those skilled in the art, various modifications and improvements may be made without departing from the essence of the present disclosure, and these modifications and improvements are further considered as the protection scope of the present disclosure.

What is claimed is:

1. A method for manufacturing a capillary structure of a uniform temperature plate, comprising:
providing copper paste having a preset porosity and a template material having a regular structure;
coating the template material and the copper paste on a substrate for drying and sintering; and
removing the template material by dissolution or high temperature decomposition to obtain the capillary structure with regular channels.

2. The method as described in claim 1, wherein coating the template material having the regular structure and the copper paste on the substrate comprises:
laying the template material on the substrate to form a template layer;
coating the copper paste on the template layer by coating or printing.

3. The method as described in claim 1, wherein coating the template material having the regular structure and the copper paste on the substrate comprises:
mixing the template material with the copper paste to form a mixed slurry;
coating the mixed slurry on the substrate by coating or printing.

4. The method as described in claim 1, wherein the template material is any one of high molecular fabric, whisker, porous foam; and/or,
a diameter of the template material ranges from 1 μm to 1 mm.

5. The method as described in claim 4, wherein the high molecular fabric is one or more of nylon, polyurethane, polyethylene terephthalate fiber, polyamide fiber, acrylic fiber, polypropylene fiber and the like; and/or,
the whisker is organic whisker or inorganic whisker; and/or,
the porous foam material is one or more of polyurethane foam, polypropylene foam, polyethylene foam, PVC foam, EVA foam and melamine foam.

6. The method as described in claim 1, wherein the drying temperature ranges from 80° C. to 150° C., and the drying time ranges from 5 min to 180 min; and/or,
the sintering temperature ranges from 300° C. to 850° C., and the sintering time ranges from 10 min to 480 min.

7. The method as described in claim 1, wherein the copper paste comprises copper powder, a pore-forming agent, a binder and a solvent.

8. The method as described in claim 7, wherein the copper powder has a mass fraction of 30% to 95% and a particle size of 50 nm to 200 μm; and/or,
the pore-forming agent has a mass fraction of 0% to 85% and a particle size of 500 nm to 100 μm; and/or,
a mass fraction of the binder is 1% to 20%.

9. A capillary structure for a uniform temperature plate, wherein the capillary structure is manufactured by the method as described in claim 1.

10. A uniform temperature plate, wherein the uniform temperature plate comprises an upper cover plate, a lower cover plate and a capillary structure, wherein,
the capillary structure is located between the upper cover plate and the lower cover plate, and the capillary structure adopts the capillary structure as described in claim 9.
